(19) United States
(12) Patent Application Publication
(10) Pub. No.: US 2025/0108397 A1
(43) Pub. Date: Apr. 3, 2025

(54) MONITORING PERFORMANCE AND MAINTENANCE STATUS OF A NOZZLE ORIFICE USING A NANOPARTICLE COATING SENSOR

(71) Applicant: Spraying Systems Co., Wheaton, IL (US)

(72) Inventors: Justin Burger, Fulshear, TX (US); Brian Robertson, Pinehurst, TX (US); Paul Vesely, Chicago, IL (US); Rudolf Schick, Forest Park, IL (US)

(21) Appl. No.: 18/900,156

(22) Filed: Sep. 27, 2024

Related U.S. Application Data
(60) Provisional application No. 63/540,976, filed on Sep. 28, 2023.

(51) Int. Cl. B05B 15/18; G01N 3/56

(52) U.S. Cl. CPC B05B 15/18; G01N 3/56

(57) ABSTRACT

A spray nozzle comprising an orifice piece is described where a nanoparticle-laden resistive material is provided with the orifice piece. Moreover, the nanoparticle-laden resistive material is physically formed to provide a measurable wear characteristic parameter, measurable by electrically energizing the nanoparticle-laden resistive material, indicative of an operational performance status of the spray nozzle. Embodiments of the present disclosure facilitate formation, application, and update of spray nozzle operational performance models to spray nozzle instances.

### CROSS-REFERENCE TO RELATED APPLICATIONS

This patent application claims the benefit of U.S. Provisional Patent Application No. 63/540,976, filed Sep. 28, 2023, entitled “MONITORING PERFORMANCE AND MAINTENANCE STATUS OF A NOZZLE ORIFICE USING A NANOPARTICLE COATING SENSOR”, which is expressly incorporated herein by reference in its entirety, including any references therein.

### TECHNICAL FIELD

The present invention relates generally to spray nozzles, and more particularly, monitoring performance and/or maintenance status of a spray nozzle orifice using an electronic circuit having a changing output characteristic of a current physical state of the orifice structure.

### BACKGROUND

Spray formation and atomization requires a considerable amount of energy and presents an abundance of technical challenges that are influenced by physical properties of a spray nozzle including, for example, surface structure of an exit orifice. Traditional methods to characterize spray performance include rendering spray nozzle parameters based upon measuring: pressure, flow, and drop size. Each of the identified parameter types is obtained by a distinct measurement device used to collect and aggregate data for performance analysis and building/updating performance models driven by the identified parameters. Additionally, it can be challenging to measure several individual nozzles affixed to a singular header or injector.

Due to a diverse spectrum of spray nozzle applications and the potentially large number of nozzles utilized in any given process, it is exceedingly difficult and cost prohibitive to gauge/characterize operational performance status of any single spray nozzle at any given point in time. For example, spray nozzle placement on a header affects a rate of preferential flow, and thus each individual nozzle will wear differently, and thus will have a different operational performance status over time. To assess individual nozzle performance, a pressure gauge and flow meter must be installed directly to a nozzle exit (e.g., fixture in an individual spray nozzle test harness) to glean true operational performance status (e.g., degree of physical wear of the spray nozzle orifice structural surface) of the nozzle.

Moreover, the relatively time and resource-intensive task of analyzing and characterizing wear patterns on spray nozzle orifice piece surfaces, that have a wide variety of complex three-dimensional surfaces, presents a challenge/barrier to developing detailed wear characterization models.

### BRIEF SUMMARY OF THE DISCLOSURE

The present disclosure is directed to a spray nozzle comprising an orifice piece. A nanoparticle-laden resistive material is provided with the orifice piece. Moreover, the nanoparticle-laden resistive material is physically formed to provide a measurable wear characteristic parameter, measurable by electrically energizing the nanoparticle-laden resistive material, indicative of an operational performance status of the spray nozzle.

In accordance with particular illustrative examples of the spray nozzle, the measurable wear characteristic parameter is a resistance.

In accordance with particular illustrative examples of the spray nozzle, the resistance is measurable using a Wheatstone Bridge.

In accordance with particular illustrative examples of the spray nozzle, the measurable wear characteristic parameter is a thermal image.

In accordance with particular illustrative examples of the spray nozzle, the thermal image is obtainable by a thermal-infrared camera.

In accordance with particular illustrative examples of the spray nozzle, the nanoparticle-laden resistive material is provided as a layer, and in still more particular illustrative examples, the layer is: provided on an exposed surface of the orifice piece; embedded within the orifice piece; a solid layer; and/or a patterned layer.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is an exemplary schematic diagram depicting a spray nozzle incorporating a nanoparticle-laden material pattern forming a conforming pattern on a surface of a spray nozzle orifice piece in accordance with the present disclosure;

FIG. 2 is a further (rotated) view of an exemplary schematic diagram depicting a spray nozzle incorporating a nanoparticle-laden material pattern forming a conforming pattern on a surface of a spray nozzle orifice piece in accordance with the present disclosure;

FIG. 3 is a photograph depicting actual orifice pieces that have been manufactured to include a nanoparticle-laden resistive material layer and terminals that facilitate taking measurements to determine changes in resistance across the terminals in accordance with the present disclosure;

FIG. 4 is an exemplary sensor signal waveform showing changes to resistance over time in response to wear of a spray nozzle orifice piece surface (while flow and pressure remain relatively unchanged); and

FIG. 5 is a detailed circuit diagram including the nanoparticle-laden surface as a resistive element in a Wheatstone bridge circuit providing a sensor signal indicative of an operational performance status of a spray nozzle in accordance with the present disclosure.

### DESCRIPTION OF ILLUSTRATIVE EXAMPLES

The present disclosure is directed to a new physical arrangement wherein a nanoparticle-laden resistive material is provided on (e.g., embedded within) a spray nozzle orifice piece. Electrically conductive terminals of the nanoparticle-laden material are connected in a sensor circuit such that the patterned nanoparticle-laden resistive material provides an orifice piece wear-sensitive circuit element of an electronic circuit (e.g., providing the “unknown” resistance of a Wheatstone Bridge resistance sensor) that senses changes in electronic properties (e.g. resistance, impedance, current, voltage, etc.) indicative of structural wear of the spray nozzle orifice piece. Additionally and/or alternatively, the nanoparticle-laden resistive material, when connected to an electrical power source, generates a thermal output that may be captured by an infrared camera-providing another way to measure (via a thermal image—as opposed to by measurement of resistance) a degree to which an orifice piece has physically degraded (e.g., a degree to which an opening of the orifice piece has widened).

After manufacture of a spray nozzle including the aforementioned nanoparticle-laden material pattern, a baseline sensor signal state for the spray nozzle is established by, for example, measuring the resistance/impedance of the material pattern (resistive element). As the nozzle orifice piece wears, portions of the nanoparticle-laden material pattern are removed, resulting in a changed electrical characteristic (e.g. resistance) for the nanomaterial-laden material pattern (as well as an infrared-thermal image that indicates physical regions of wear).

Moreover, application of the information acquired from devices incorporating of the present disclosure facilitate formation, application, and update of spray nozzle operational performance models to spray nozzle instances. By modeling orifice piece wear according to sensed electrical characteristics, a correlation can be established between sensor values and spray nozzle operational performance. As such, the nanoparticle-laden material pattern-when connected to an appropriate sensory circuit-enables characterizing wear patterns for each of a variety of spray nozzle orifice surface patterns. The baseline measurements can be used to indicate the significance of changes to resistance measures in a particular operating environment characterized by one or more parameters of the group consisting of: pressure, flow, spray angle, temperature, humidity and various qualities of material passing through the orifice of a spray nozzle.

More particularly, the present disclosure relates generally to modifications to a spray nozzle orifice piece structure to incorporate a resistive element, in the form of a nanoparticle-laden resistive material pattern, that wears (and thus changes resistance) in association with a wear pattern of an orifice piece of a spray nozzle. The material pattern, being resistive, generates heat when current passes through the material, and as such is viewable by a thermal/infrared camera in particular physical configurations.

The disclosure is further directed to a coordinated data acquisition and processing arrangement for facilitating monitoring and indirectly estimating a current operational performance status of a spray nozzle orifice using an electronic sensor circuit incorporating a varying impedance element provided by providing a conforming nanoparticle-laden resistive/conductive material pattern on a wear surface of the spray nozzle orifice piece. An electrical characterizing parameter (e.g. resistance) value of the nanoparticle-laden material pattern is correlated to spray nozzle operational performance metrics including: pressure, flow rate, temperature, humidity, and other metrics to glean overall nozzle operational performance.

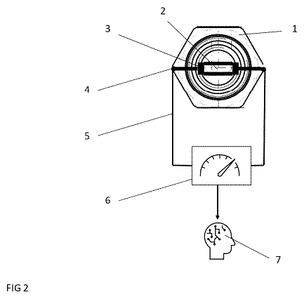

Embodiments of the present disclosure provide a spray nozzle including a conductive material applied/affixed to, embedded within, or otherwise incorporated into an orifice piece structure of a spray nozzle (see FIG. 2) to obtain an indication of operational performance changes of a spray nozzle based on changes of resistance measurement values across the nanoparticle-laden resistive material pattern as the nozzle orifice piece structure wears and/or as surrounding conditions change. Such electrical resistance measurements and changes thereto are used to develop and apply operational performance models for associated/related spray nozzles. A change in resistance, for example, indicates a change in nozzle structural conditions and thus the operational performance status of the nozzle. By way of a specific example, a “worn” nozzle is characterized by a relatively higher resistance measured since part of the nanoparticle-laden resistive material pattern has been removed. Such increase in resistance of the nanoparticle-laden material resistive pattern indicates a degraded physical state of the orifice piece in which the nanoparticle-laden material is applied/incorporated.

Through proper configuration of analytical models (e.g. machine learning), a proper characterization of a present status of a spray nozzle, and an associated remedial action, may be ascertained without any human intervention.

A resistance measuring device (Wheatstone Bridge) and code interpret the measured resistances of the nanomaterial-laden material pattern to generate data points which indicate the condition of the nozzle orifice piece and environment. The measurements over time are aggregated and used to assess nozzle performance where an increase in resistance over time is used to indicate a change in nozzle operational performance and/or surrounding conditions.

By way of a particular example, insertion of conductive material on vacuum formed orifice plates is one particular way to provide the conductive material on molded spray nozzle office piece assemblies.

A method to apply the coating on a “v” cut orifice piece will now be described. Initially, a “v” portion of the orifice piece is cut. Thereafter, insulating material is applied followed by application of a nanoparticle-laden resistive material pattern. Thereafter, a final coat of insulating material is applied, followed by cutting an opening of the orifice piece to size. Since the nozzle wears from the inside, the nanoparticle-laden resistive material (e.g., carbon nanoparticle material (CNT)) will slowly be removed as the material of the orifice piece wears. Thus, the CNT material in its macro form (as a patterned layer) is softer than the material making up the orifice piece, and thus will wear away with the orifice piece material as the underside of the nozzle wears. The wearing away of the nanoparticle-laden resistive material from the layer results in a measurable increase in resistance across opposing terminals of the layer.

During manufacture, the nanoparticle-laden resistive material may be applied via super critical assisted atomization (SAA) to ensure spray deposition uniformity of the conductive material. This application method allows for the nanoparticle-laden resistive material to be tailored based on desired sensitivity. The SAA method allows for nanocoating to be applied with a high degree of precision and accuracy, and based on the CNT formulation the nanoparticle-laden material is adhered to the substrate (nozzle) with a coating that is only a few microns thick. As noted previously, the orifice piece wears away from the opening thereof outward. Therefore, once an outer portion of the nozzle orifice is compromised, the CNT material is “sluffed off” with the orifice piece base material in its “macro” form which results in an increased resistance (due to a smaller cross-section) and thus provides an indication the orifice piece opening has enlarged. The SAA method affords an opportunity to alternate between “disc” and “dome” formations of the deposited substrate, which also provides sensitivity of measurement that can be tailored to each unique operating environment.

Additionally, a “micro grid” mask may be affixed around the annulus of the orifice piece as the CNT coating is applied. The space of the “micro grid” provides differing degrees of resolution as each portion of the grid erodes over time acting as a “fuse” for the nozzle. As each individual circuit within the grid is comprised due to wear, the signal changes (resistance increases) and thus it is known that the opening of the orifice piece has increased.

The application of the conductive material may utilize a mask with a defined distance away from the nozzle orifice piece while ensuring the orifice piece is covered. As the nozzle wears, the conductive material is encroached upon due to erosive forces thus causing a change in resistance measurements. In this arrangement, the patterned segments/parts of the nanoparticle-laden resistive material layer act as discrete fuses that, when broken, result in an increase in resistance that indicates an amount of erosion occurring with respect to an opening of the orifice piece. Through modeling, a predetermined change in resistance can be interpreted as an indication of a particular degradation of operational performance of the spray nozzle containing the orifice piece under observation.

Another method of affixing the CNT material is using a pre-formed “sticker”. The sticker is laser cut to sizes that may indicate a critical wear path to inform the state of the nozzle. For example, the sticker can be placed ten microns from the periphery of the orifice piece. As the sticker is abraded at the pre-determined distance from the orifice, the measured resistance across terminals of the CNT material layer increases, and thus provides an indication that an opening within the orifice piece has enlarged. The sticker is affixed to the orifice piece of the nozzle and coated with an insulative adhesive. Once the insulative adhesive is worn away exposing the CNT material, the resistance will change as the CNT base material is abraded.

The present disclosure contemplates using predictive wear rates with paired liquid quantification and material selection to determine appropriate/remedial action with regard to particular spray nozzle instances. Moreover, water quality metrics may be used for informative nozzle performance (temperature, heat, solids content, viscosity, etc.) modeling.

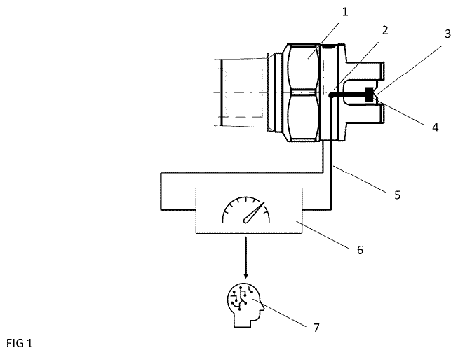

Referring to FIG. 1, an exemplary schematic diagram is depicted of a spray nozzle 1 depicted in cross-section that incorporates a nanoparticle-laden material pattern within an orifice piece in accordance with the present disclosure. The nozzle 1 includes an orifice piece that incorporates a nanoparticle-laden resistive material layer 4 proximate an orifice opening 3. The material layer 4 is connected to terminals (terminal 2 shown). The terminals, in turn, are contacted, during testing/measuring, to wires 5 that connect the material layer 4 is the unknown resistance element of a Wheatstone Bridge resistance measurement device incorporated into measuring device 6. The measurements acquired by the measuring device 6 are accumulated and processed using, for example, a trained machine learning processing node 7, to render a diagnostic/remedial result.

Turning to FIG. 2 a further (rotated) view is provided of the exemplary arrangement of a spray nozzle incorporating a nanoparticle-laden material pattern forming a conforming pattern on a surface of a spray nozzle orifice in accordance with the present disclosure. In FIG. 2, the view of FIG. 1 is rotated such that a better view is provided of the nanoparticle-laden resistive material layer 4 around the opening 3.

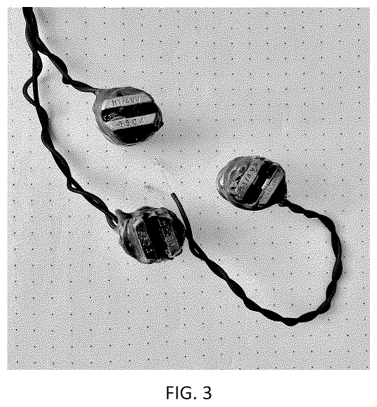

Turning to FIG. 3, a photograph is provided depicting actual orifice pieces that have been manufactured to include the material layer 4 and terminals 2 that facilitate taking measurements to determine changes in resistance across the terminals 2 in accordance with the present disclosure.

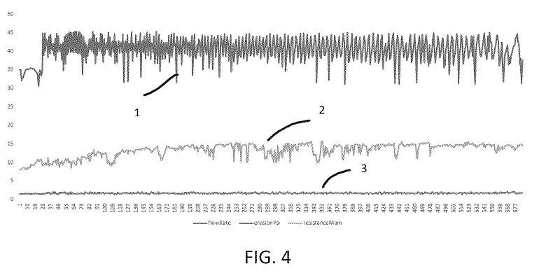

Turning to FIG. 4, an exemplary sensor signal waveform is provided showing changes to resistance over time in response to wear of a spray nozzle orifice piece surface. It is interesting to note that of the three signals/measurements (flow 3, pressure 1, and resistance 2), the “resistance” signal 2 demonstrates the most change as the nozzle orifice piece exhibited wear-resulting in a larger opening of the orifice piece.

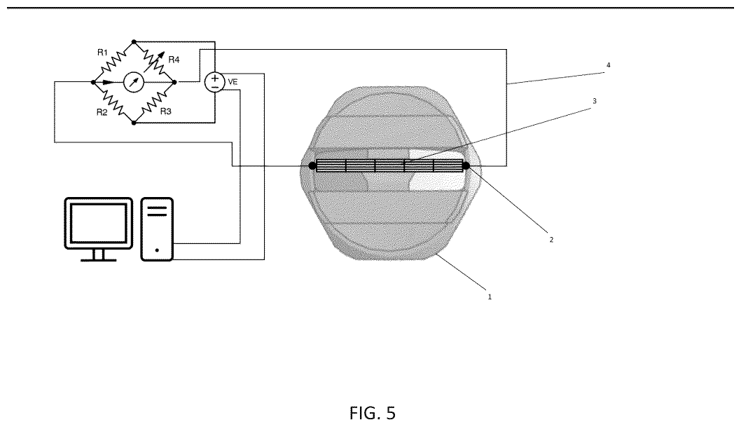

Turning to FIG. 5, a system diagram including a detailed circuit diagram of the Wheatstone Bridge is provided that also includes an exemplary configuration of the nanoparticle-laden surface as a resistive element in a Wheatstone bridge circuit providing a sensor signal indicative of an operational performance status of a spray nozzle in accordance with the present disclosure. A schematic of the detailed resistance measurement circuit is provided along with a coating arrangement that exhibits characteristics of the material layer 4 that provides a way to identify certain discrete “states” of progressive wear of the orifice piece opening 3 through erosion of the material layer 4 (and resulting changes in measured resistance using the Wheatstone Bridge). Item 3 in FIG. 5 illustratively depicts a grid representing portions of the orifice piece that may wear away over time, resulting in a changed resistance across the measurement terminals. As the grid loses connections due to wearing away of the orifice piece (resulting in a larger opening) of the nozzle, the various states of the nozzle can be discerned at quantifiable increments. For example, the grid affixed in a fashion where known intervals are affixed throughout the periphery of the orifice, levels of granularity can be achieved based on the modeled changes to resistance that accompany each loss of a span of the grid. The closer the grid segments are to one another the more granular the resulting signal measurements. The wires 5 from the Wheatstone Bridge carry a resistance measurement value rendered by the Wheatstone Bridge that are conditioned and analyzed (provided to a machine learning model) to render an output (e.g. a remedial action, a percentage of remaining life, a degree of degradation from original specification, etc.). Such analysis is based upon the basic premise that, as the nozzle wears the resistance changes (increases), and such change indicates a potential change in the operational performance state of the nozzle.

Another aspect of the present disclosure is the classification/grouping of nozzle configurations to which particular trained (machine learning) models may be applied—as well as determining which nozzle instances can be used to provide further training data for existing models. Nozzle type orifice geometry is paired with spray deposition of the pattern.

Other aspects of implementations of the present disclosure include: aggregating data based on nozzle type; training based on nozzle materials and calculating remaining lifetime values based on prevailing conditions and predicted failure modes; using grid based versus solid surface performance; using several models based on a central artificial intelligence (AI) database to glean performance indicators; and generating decision points for nozzle replacement coming from recommendations based on application and sensitivity to degradation mechanisms; patterns of predicted trained models to replace the nozzles.

The present disclosure facilitates measuring the resistivity across (or capturing a thermal image of) a substrate that “surrounds” an opening of an orifice piece. Wire leads are connected across the resistive (heat generating) material (e.g., Pristine Carbon Nanotubes) affixed to/embedded within the orifice piece in a manner that, when electrically energized, is indicative of an operational performance-relevant physical aspect of the orifice piece (e.g., the orifice piece opening). Thereafter, the material layer physically changes in accordance with physical changes to an opening of the orifice piece, and such changes are sensed/measured through changes in measured resistance (using, for example, a Wheatstone Bridge) or by thermal viewing using an infrared camera to generate a thermal image identifying a current extent of the material layer affixed to/embedded within the orifice piece. Such measurement is facilitated by the physical properties of the nanoparticle-laden resistive material layer that enable such layer to wear in accordance with a wear pattern at the opening of the orifice piece.

In summary of the disclosure provided herein, a physical arrangement has been described wherein a nanoparticle-laden material is patterned on a spray nozzle orifice piece surface and connected in a sensor circuit such that the patterned surface provides an orifice piece wear-sensitive circuit element of an electronic circuit that senses changes in electronic properties (e.g. impedance, current, voltage, etc.) indicative of structural wear of the spray nozzle orifice piece surface.

After manufacture of a spray nozzle including the aforementioned nanoparticle-laden material pattern, a baseline sensor signal state for the spray nozzle is established by, for example, measuring the resistance/impedance of the material pattern (resistive element). As the nozzle orifice piece wears, portions of the nanoparticle-laden material pattern are removed, resulting in a changed electrical characteristic (e.g. resistance, conductivity, etc.) for the material pattern. By modeling orifice piece wear according to sensed electrical characteristics, a correlation can be established between sensor values and spray nozzle operational performance. As such, the nanoparticle-laden material pattern-sensory circuit-enables characterizing wear patterns for each of a variety of spray nozzle orifice piece surface patterns. The baseline measurements can be used to indicate the significance of changes to resistance measures in a particular operating environment characterized by one or more of parameters of the group consisting of: pressure, flow, spray angle, temperature, humidity and various qualities of material passing through the orifice of a spray nozzle.

As such methods, systems and devices have been described for establishing various states of a nozzle. The baseline state of the nozzle is established by measuring the resistance of the nozzle that is coated with conductive material before the nozzle has ever been used to spray material. As the nozzle wears and/or the environment changes, the resistance of the sensory circuit of the nozzle changes thus indicating a change from the baseline reading.

Moreover, the nozzle sensory structure/circuit can be “programmed” from several calibrating systems to affix changes to resistance with changes to various baseline measurements such as pressure, flow, spray angle, temperature, humidity and even various qualities of the liquids being sprayed through the nozzle thus affording deep analytics to the state of the nozzle.

It will be appreciated that the foregoing description relates to examples that illustrate a preferred configuration of the system. However, it is contemplated that other implementations of the invention may differ in detail from foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A spray nozzle comprising an orifice piece, wherein a nanoparticle-laden resistive material is provided with the orifice piece, and
wherein the nanoparticle-laden resistive material is physically formed to provide a measurable wear characteristic parameter, measurable by electrically energizing the nanoparticle-laden resistive material, indicative of an operational performance status of the spray nozzle.

2. The spray nozzle of claim 1, wherein the measurable wear characteristic parameter is a resistance.

3. The spray nozzle of claim 2 wherein the resistance is measurable using a Wheatstone Bridge.

4. The spray nozzle of claim 1, wherein the measurable wear characteristic parameter is a thermal image.

5. The spray nozzle of claim 4, wherein the thermal image is obtainable by a thermal-infrared camera.

6. The spray nozzle of claim 1, wherein the nanoparticle-laden resistive material is provided as a layer.

7. The spray nozzle of claim 6, wherein the layer is provided on an exposed surface of the orifice piece.

8. The spray nozzle of claim 6, wherein the layer is embedded within the orifice piece.

9. The spray nozzle of claim 6, wherein the layer is a solid layer.

10. The spray nozzle of claim 6, wherein the layer is a patterned layer.
